(19) United States
(12) Patent Application Publication
(10) Pub. No.: US 2007/0160097 A1
(43) Pub. Date: Jul. 12, 2007

(54) Heat sink for a pulsed laser diode bar with optimized thermal time constant

(75) Inventors: Martin Behringer, Regensburg (DE); Gerhard Herrmann, Bernhardswald (DE); Stefan Morgott, Regensburg (DE); Frank Mollmer, Pentling (DE)

Correspondence Address: COHEN, PONTANI, LIEBERMAN & PAVANE, 551 FIFTH AVENUE, SUITE 1210, NEW YORK, NY, 10176, US

(73) Assignee: Osram Opto Semiconductors GmbH, Regensburg (DE)

(21) Appl. No.: 10/580,972

(22) PCT Filed: Nov. 24, 2004
(86) PCT No.: PCT/DE04/02603

§ 371 Date: Feb. 21, 2007

(30) Foreign Application Priority Data
Nov. 28, 2003 (DE) 103 55 602.8
Jan. 27, 2004 (DE) 10 2004 004 097.4

(51) Int. Cl. H01S 3/10; H01S 3/04

(52) U.S. Cl. 372/34; 372/25

(57) ABSTRACT

A radiation-emitting optoelectronic component (1) which is connected to a heat sink (3) and is intended for pulsed operation with the pulse duration D, and in which temperature changes of the optoelectronic component (1) take place with a thermal time constant τ during pulsed operation. The thermal time constant τ is matched to the pulse duration D in order to reduce the amplitude of the temperature changes.

This patent application claims the priority of German patent applications 102004004097.4 and 10355602.8, the disclosure content of which is hereby incorporated by reference.

In the case of radiation-emitting optoelectronic components for high-power operation, it is necessary to suitably dissipate the power loss which occurs in the form of heat since heating of the component has a disadvantageous effect on the optical properties and long-term stability. In particular, a temperature increase may give rise to a shift in the wavelength, reduced efficiency, a shorter service life or even the destruction of the component. For this reason, optoelectronic components are often mounted on a heat sink during high-power operation. Both passive heat sinks, for example a copper block, and active heat sinks, for example heat sinks having a microchannel system through which a liquid flows, are known.

A microchannel heat sink for high-power laser diodes is described, for example, in DE 43 15 580 A1. In order to ensure good heat dissipation, an attempt is made, in such microchannel heat sinks, to keep the thermal resistance between the component and the heat sink as low as possible. This is effected, for example, by virtue of the wall thickness of the walls between the microchannels and the outer wall of the heat sink being kept low on the side adjoining the optoelectronic component. In addition to the thermal resistance, this also reduces the thermal capacitance of the heat sink.

The temporal profile of the temperature changes of an optoelectronic component during a switching operation can often be approximately described by the exponential function

$$Δ T ( t - {t}_{1} ) = Δ {T}_{∞} ( 1 - {ⅇ}^{\frac{t - {t}_{1}}{τ}} )$$

in the case of temperature increases and the exponential function

$$Δ T ( t - {t}_{2} ) = Δ T ( t = {t}_{2} ) {ⅇ}^{\frac{t - {t}_{2}}{τ}}$$

in the case of temperature decreases.

ΔT(t) is the temperature change, that is to say the difference between the instantaneous temperature and the initial temperature at the time t, t₁ and t₂ being the associated switching times for a temperature increase and a temperature decrease, respectively. ΔT_{∞} is the limiting value of the temperature increase, toward which ΔT(t) would converge for t->∞. This limiting value would be reached, for instance, in the case of a relatively long operating time in cw operation.

An attempt is usually made to minimize this limiting value in order to keep the maximum temperature of the component as low as possible. ΔT_{∞} depends, in particular, on the thermal resistance between the optoelectronic component and the heat sink. τ is a thermal time constant which likewise depends on various parameters, for example on the thermal capacitance, the thermal resistance to the heat sink or the heat-radiating area of the component. The greater τ is, the more slowly the temperature changes take place.

In the case of optoelectronic components which are operated in a pulsed manner, there is the risk, in particular at low frequencies, of the component being exposed to fluctuating mechanical loads on account of temperature changes at the pulse frequency. This results in fluctuating mechanical loads which could impair the operation of the component or could even destroy it.

The invention is based on the object of providing an optoelectronic component having a heat sink, in which the fluctuating mechanical loads which result from pulsed operation are reduced. Furthermore, a method for producing said component is to be specified.

According to the invention, this object is achieved by means of an optoelectronic component as claimed in patent claim 1 and a method as claimed in patent claim 13 or patent claim 14. The dependent claims relate to advantageous refinements and developments of the invention.

According to the invention, in the case of a radiation-emitting optoelectronic component which is connected to a heat sink and is intended for pulsed operation with the pulse duration D, and in which temperature changes of the optoelectronic component take place with a thermal time constant τ during pulsed operation, the thermal time constant τ is matched to the pulse duration D in order to reduce the amplitude of the temperature changes. The amplitude of the temperature changes is understood as meaning the difference between the highest and lowest temperature of the optoelectronic component during a pulse. The thermal time constant is the constant τ in the equations specified above for ΔT(t). In the case of a temperature profile which differs from these relationships, the thermal time constant τ of an optoelectronic component is to be understood, in the context of the invention, as meaning the best approximation for τ, which can be determined, for example, by matching the curve of the abovementioned equations to the actual temperature profile. When in doubt, the time which corresponds to a temperature drop which has been extrapolated, if appropriate, to 1/e times the initial temperature may be used for this purpose.

In a preferred manner, the thermal time constant τ of the temperature changes of the optoelectronic component during pulsed operation is τ≧0.5 D. In a particularly preferred manner, it is τ≧D.

A thermal time constant which has been matched to pulsed operation in such a manner advantageously results in the temperature changes being relatively small during pulsed operation. A fluctuating mechanical load on the optoelectronic component as a result of temperature-dictated mechanical stresses is thus reduced.

By way of example, at the end of a pulse, that is to say for t=D, ΔT(t) is approximately 0.86 ΔT_{∞} for τ=0.5 D and is approximately 0.63ΔT_{∞} for τ=D. It may also be advantageous to use larger values for τ in order to reduce the temperature increase at the end of a pulse even further. By way of example, ΔT(t=D) is approximately 0.39 ΔT_{∞} for τ=2D or is approximately 0.283 ΔT_{∞} for τ=3D.

Such optimization of the thermal time constant is based on the knowledge that, in addition to the maximum temperature reached, temperature changes have a decisive influence on the long-term stability of the component. It is therefore expedient to minimize the amplitude of the temperature changes.

In order to increase the thermal time constant τ, measures which increase the thermal resistance between the heat sink and the optoelectronic component are necessary under certain circumstances. This may result in an increase in the limiting value ΔT_{∞}. On the other hand, however, the dissipation of heat from the optoelectronic component to the heat sink should be large enough to avoid the maximum temperature, which is reached after a relatively long operating time, exceeding a value which is still acceptable. Therefore, a compromise must generally be found between an acceptable value for ΔT_{∞} and an acceptable value for τ.

In order to improve the long-term stability in pulsed optoelectronic components, the invention thus results in a reduction in the temperature changes being advantageous, as regards the long-term stability of the component itself, even if the reduced changes take place at a somewhat higher temperature level than larger changes at a comparatively somewhat lower temperature level.

In the case of the invention, the temperature changes during pulsed operation are preferably reduced to a value of less than ΔT =12 K.

The invention is particularly advantageous for radiation-emitting optoelectronic components whose output power is 20 W or more and/or whose pulse frequency is between 0.1 Hz and 10 Hz. In particular, the radiation-emitting optoelectronic component may be a laser diode bar.

The heat sink to which the optoelectronic component is connected is preferably an actively cooled heat sink. This may have, for example, a microchannel system through which a coolant, for example water, flows.

The optoelectronic component is connected to a surface of the heat sink using a soldered connection, for example.

The thermal time constant τ is advantageously dimensioned by the wall thickness of a wall of the microchannel system that adjoins the optoelectronic component. This wall thickness is advantageously 0.5 mm or more. The wall thickness is particularly preferably 1 mm or more, for example between 1 mm and 2 mm inclusive.

The heat sink may contain copper, in particular. However, other materials which have good thermal conductivity are also conceivable in the context of the invention.

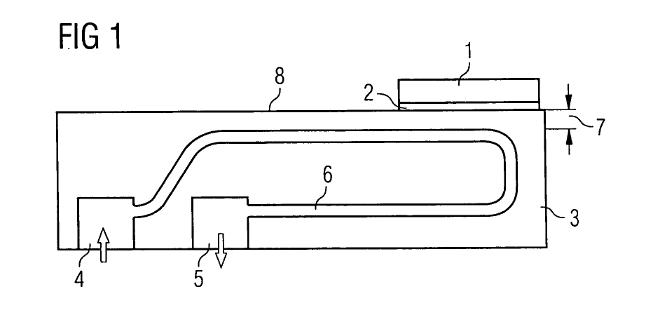

The invention is explained in more detail below with reference to an exemplary embodiment in connection with FIGS. 1 to 3, in which:

FIG. 1 shows a schematically illustrated cross section through an exemplary embodiment of an optoelectronic component according to the invention,

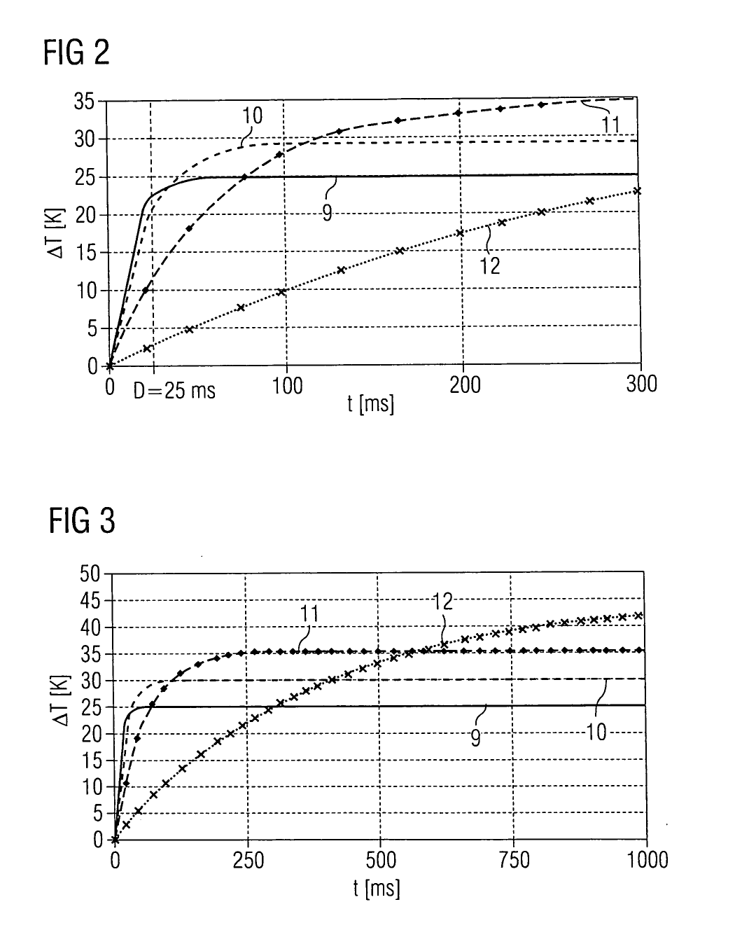

FIG. 2 shows a simulation of the heating of an optoelectronic component on a time scale from 0 ms to 300 ms for four different embodiments of a heat sink, and

FIG. 3 shows a simulation of the heating of an optoelectronic component on a time scale from 0 ms to 1000 ms for four different embodiments of a heat sink.

The optoelectronic component 1 which is schematically illustrated in FIG. 1 is connected to a heat sink 3. To this end, it is fastened to a surface 8 of the heat sink 3 using a soldered connection 2, for example. In this example, the heat sink 3 is an actively cooled heat sink having a microchannel system 6 with an inflow 4 and an outflow 5 for a coolant which flows through the microchannel system 6. The coolant is a liquid, in particular water, or a gas.

The radiation-emitting optoelectronic component 1 emits pulses with a pulse duration D. In particular, the optoelectronic component 1 may be a high-power diode laser or a high-power diode laser bar. The invention is particularly advantageous for radiation-emitting optoelectronic components 1 having an output power of 20 W or more.

The pulses are emitted at a pulse frequency f which is, for example, between 0.1 Hz and 10 Hz. The pulse duration D is shorter than the period tₚ=1/f. The ratio of the pulse duration D to the period tₚ is usually referred to as the duty ratio q, that is to say D=q*tₚ.

The heat sink 3 serves, on the one hand, to dissipate the heat which is produced as a result of the power loss of the optoelectronic component 1. Setting the thermal constant τ to a value of τ>0.5 D, preferably τ>D, also reduces the temperature changes during pulsed operation.

The thermal time constant τ may be set, for example, by dimensioning the wall thickness 7 of that wall of the heat sink 3 which adjoins the optoelectronic component 1. This wall thickness corresponds to the distance between that surface 8 of the heat sink 3 which faces the optoelectronic component 1 and the microchannel 6 which is closest to the surface 8.

Increasing the wall thickness 7 gives rise to an increase in the thermal time constant τ. This is illustrated by the simulation calculations (illustrated in FIGS. 2 and 3) of the time dependence of the temperature increase ΔT of an optoelectronic component 1 for various values of the wall thickness 7. Curve 9 represents the temporal profile of the temperature increase for an actively cooled heat sink having a wall thickness of 0.1 mm, curve 10 represents the temporal profile of the temperature increase for an actively cooled heat sink 3 in which the wall thickness 7 is equal to 1 mm, curve 11 represents the temporal profile of the temperature increase for an actively cooled heat sink 3 in which the wall thickness 7 is equal to 2 mm, and curve 12 represents the temporal profile of the temperature increase for a passive heat sink which is formed by a copper block without an actively cooled microchannel system. The thermal time constants τ are approximately 10 ms for a wall thickness of 0.1 mm (curve 9), approximately 20 ms for a wall thickness of 1 mm (curve 10), approximately 60 ms for a wall thickness of 2 mm (curve 11) and approximately 400 ms for the passive heat sink (curve 12).

An increase in the thermal time constant τ, which is achieved in curves 9 and 10 by increasing the wall thicknesses 7 or in curve 12 by using a passive heat sink, is advantageous if the thermal time constant τ is greater than half the pulse duration D, preferably greater than the pulse duration D. In the first case, the temperature increase ΔT reaches at most approximately 86% of the limiting value ΔT_{∞} and, in the second case, reaches approximately 63% of the limiting value ΔT_{∞}.

With a pulse duration of, for example, D=25 ms, the condition τ>0.5 D is satisfied, according to the invention, for the active heat sink having a wall thickness of 1 mm (curve 10) since, for the latter, τ=20 ms and is thus greater than 0.5 D=12.5 ms. This also applies to the heat sink having a wall thickness of 2 mm (curve 11) where τ=60 ms and the passive heat sink (curve 12) where τ=400 ms. In contrast, this condition is not satisfied for the active heat sink having a wall thickness of 0.1 mm (curve 9) where τ=10 ms. The condition τ>D, which is preferred in the invention, is satisfied for this pulse duration only for the active heat sink having a wall thickness of 2 mm (curve 11) and for the passive heat sink (curve 12). As is clearly evident from FIG. 2, the inventive matching of the thermal time constant τ to the pulse duration D advantageously reduces the temperature changes during the pulse duration.

In contrast to an optoelectronic component in pulsed operation, an increase in the wall thickness 7 or the use of a passive heat sink is disadvantageous for an optoelectronic component in cw operation since in this case, as simulated in FIG. 3, a higher value of the temperature increase ΔT would be established after a relatively long operating time. This is because the actively cooled heat sinks having an increased wall thickness 7 or the passive heat sink have/has an increased thermal resistance between the optoelectronic component 1 and the heat sink 3.

For an optoelectronic component which is intended for use in pulsed operation, it is possible, with relatively little complexity, by dimensioning the wall thickness of the heat sink, to vary the thermal time constant and thus to provide a heat sink which is optimally matched to pulsed operation. However, other alternatives for setting the thermal time constant τ on the basis of the pulse duration provided are also conceivable. For example, the area and/or the thickness of the substrate on which the optoelectronic component is formed could also be varied.

It goes without saying that the explanation of the invention with reference to the exemplary embodiment is not to be understood as being a restriction to the latter. Rather, the invention includes the disclosed features both individually and in any combination with one another even if these combinations are not explicitly specified in the claims.

1. A device comprising:
a heat sink; and
a radiation-emitting optoelectronic component which is connected to said heat sink and is intended for pulsed operation with the pulse duration D,
wherein said heat sink is arranged such that temperature changes of the optoelectronic component take place with a thermal time constant τ during pulsed operation, and
wherein the thermal time constant τ is matched to the pulse duration D in order to reduce the amplitude of the temperature changes.

2. The device as claimed in claim 1,
wherein
the thermal time constant τ is τ>0.5 D for.

3. The device as claimed in claim 1,
wherein
the thermal time constant τ is τ>D.

4. The device as claimed in claim 1,
wherein
the temperature changes are less than ΔT =12 K.

5. The device as claimed in claim 1,
wherein
pulsed operation is effected at a pulse frequency in the range from 0.1 Hz to 10 Hz.

6. The device as claimed in claim 1,
wherein
the optoelectronic component has an optical output power of 20 W or more.

7. The device as claimed in claim 1,
wherein
the heat sink is actively cooled.

8. The device as claimed in claim 7,
wherein
the heat sink has one or more microchannels through which a coolant flows.

9. The device as claimed in claim 8,
wherein
a wall of the heat sink that adjoins the optoelectronic component has a wall thickness of 0.5 mm or more.

10. The device as claimed in claim 8,
wherein
a wall of the heat sink that adjoins the optoelectronic component has a wall thickness of between 1 mm and 2 mm inclusive.

11. The device as claimed in claim 1,
wherein
the heat sink contains copper.

12. The device as claimed in claim 1,
wherein
the optoelectronic component is a laser diode bar.

13. A method for producing the device as claimed in claim 8,
wherein
a wall of the heat sink that adjoins the optoelectronic component has a wall thickness and the temperature change and/or the maximum temperature of the component during operation is set by dimensioning the wall thickness.

14. A method for producing a device having a radiation-emitting optoelectronic component which is connected to a heat sink and is intended for pulsed operation with the pulse duration D, temperature changes of the optoelectronic component taking place with a thermal time constant τ during pulsed operation, the method comprising:
setting the thermal time constant τ to match the pulse duration D in order to reduce the amplitude of the temperature change.

15. The method as claimed in claim 14,
wherein
the thermal time constant τ is set by dimensioning the area and/or the thickness of a substrate on which the optoelectronic component is produced.
